(19) United States
(12) Patent Application Publication
(10) Pub. No.: US 2025/0179716 A1
(43) Pub. Date: Jun. 5, 2025

(54) APPARATUS FOR DRYING AND/OR WASHING LAUNDRY PROVIDED WITH AN AUTONOMOUS FIRE EXTINGUISHING DEVICE

(71) Applicant: HUTCHINSON, PARIS (FR)

(72) Inventors: Eric BOSSARD, LA SELLE EN HERMOY (FR); Olivier HIESSE, SAINT AVERTIN (FR); Robin DOMINIAK, TORINO (IT); Clément BRET, TORINO (IT); Nicola MORETTI, GASSINO TORINESE (IT); Sophie ESTEVE, TOURS (FR)

(21) Appl. No.: 18/836,402

(22) PCT Filed: Feb. 9, 2023
(86) PCT No.: PCT/EP2023/053188

§ 371 Date: Aug. 7, 2024

(30) Foreign Application Priority Data
Feb. 10, 2022 (FR) FR2201160

(51) Int. Cl. D06F 37/42; A62C 3/16; D06F 39/12

(52) U.S. Cl. CPC D06F 37/42; A62C 3/16; D06F 39/12

(57) ABSTRACT

The invention relates to an apparatus for drying and/or washing laundry, the apparatus comprising: —an outer casing (12) having an opening (14) for loading the laundry; —a drum (16) located inside the casing (12) and being rotatably movable on an axis (A), said drum (16) having an inner cavity (18) connected to the loading opening (14) and being configured to receive the laundry; —a door (22) for closing the loading opening (14); and —at least one autonomous fire extinguishing device (30), said device (30) having at least one element made of a thermoplastic fusible material and an inner space (34) containing an extinguishing fluid intended to be released when the element melts under the effect of the heat generated by a fire or fire outbreak, characterised in that the extinguishing device (30) is located at least partially inside the cavity (18).

### TECHNICAL FIELD OF THE INVENTION

This invention relates to an apparatus for drying and/or washing laundry provided with an autonomous extinguishing device for fire or fire outbreak.

### TECHNICAL BACKGROUND

The patent application FR-A1-2 614 209 describes a fire-fighting device for electrical apparatus containing flammable elements, in particular for washing machines and tumble dryers.

An apparatus for drying and/or washing laundry is an electrical household apparatus comprising a rotating drum into which laundry are placed for washing with water and a cleaning agent, or wet laundry for tumble drying. The drum is usually driven in rotation by a belt, which in turn is driven by an electric motor. A washing machine may have a tumble dryer function. In both cases, a flow of hot air may be passed through the drum of the apparatus to help dry the laundry as they are tumbled. The system for heating and generating the flow of hot air in the apparatus may comprise a gas burner or an electric resistance, for example.

This household apparatus is the cause of many domestic fires. Heating and tumbling the laundry in the drum generates flammable dust which accumulates inside the apparatus and is likely to catch fire, particularly when deposited on very hot parts of the apparatus such as the motor or the heating system. A fire outbreak caused by the ignition of dust may cause a larger fire in the apparatus, particularly by igniting the drum drive belt.

The patent application referred to above proposes to install a reservoir in the form of a pressurized bomb in a washing machine, this reservoir being connected to normally closed pipes which are liable to rupture at a given temperature threshold. These pipes extend to the parts of the apparatus that are liable to overheat or catch fire, such as electrical devices, resistors, the motor, flammable elements, etc. The fire-fighting substance contained in the reservoir is at least slightly pressurized and the distribution pipes are made of a material configured to melt in order to ensure the rupture or the opening of these pipes when the latter are licked by flames or when the temperature of their environment exceeds a predetermined threshold. In this way, as soon as conditions of overheating or flammability arise that could give rise to a fire inside the apparatus, the pipes break and automatically distribute the fire-fighting substance to immediately extinguish the development of a possible fire.

The solution described in this patent application is not entirely satisfactory, however, because the fire extinguishing system formed by the reservoir and the pipes is complex and time-consuming to install in a household apparatus. The applicant's patent application FR-A1-3 110 608 describes a laundry drying and/or washing apparatus comprising an autonomous fire extinguishing device. This device is mounted in the casing and comprises a thermoplastic fusible hose which is preformed and contains an extinguishing fluid configured to be released when the hose melts under the effect of the heat generated by a fire or fire outbreak. The special shape of the hose means it may be fitted inside the casing and run through areas where there is a high risk of fire spreading.

However, when the fire starts in the drum, it may be difficult to contain or extinguish with the existing solutions. The solvent residues in the clothes are likely to accelerate the spread of the fire in the cavity of the drum, making it difficult to extinguish. There is therefore a need for a solution that allows to guarantee that a fire or fire outbreak is extinguished as soon as it appears inside the drum of the apparatus.

The documents US-A1-213/139404 and EP-B1-2 360 310 propose that laundry tumbling bosses may be used in the drum as fire extinguishing devices. However, depending on the nature of the extinguishing material, the quantity of this extinguishing material contained in the tumbling bosses is not always sufficient to extinguish a fire or fire outbreak in the drum. Furthermore, the release of the extinguishing material is not always automatic or sufficiently optimized, as the outlets of the tumbling bosses through which the extinguishing material may pass to extinguish flames are highly localized and predetermined at the design stage of the tumbling bosses.

The present invention provides a solution to at least some of the problems of the prior art, which is simple, effective and economical.

### SUMMARY OF THE INVENTION

The invention provides an apparatus for drying and/or washing laundry, comprising:
an outer casing of generally parallelepiped shape, this casing comprising walls, at least one of which comprises a laundry loading opening,
a drum located in said casing and being rotatably movable about an axis, said drum comprising an inner cavity connected to the loading opening and configured to receive the laundry,
a door for closing the loading opening, this door being movable between positions for closing and opening said cavity, and
at least one autonomous fire extinguishing device, this device comprising at least one element made, preferably entirely, of thermoplastic fusible material and an inner space containing an extinguishing fluid configured to be released when the element melts under the effect of the heat generated by a fire or fire outbreak,
   characterized in that the extinguishing device is located at least partly in said cavity.

Firstly, it is important to note that the fluid, which may be under pressure, is stored directly in the device, so there is no independent reservoir connected to this device.

One of the advantages of the extinguishing device is that it may be specially designed and shaped for its integration into a laundry drying and/or washing apparatus. This means it takes up very little overall dimension.

Another advantage of the device is that it is at least partly located directly in the laundry drying cavity and is therefore ideally located to extinguish a fire or a fire outbreak that starts in this cavity.

In addition, if required, the extinguishing device may be easily accessed by opening the door. The access would be useful, for example, during maintenance or monitoring of the extinguishing device.

The apparatus according to the invention may comprise one or more of the following characteristics, taken in isolation from each other or in combination with each other:
the extinguishing device is carried by the drum;
said element of the extinguishing device is a tubular ring or a portion of a tubular ring, which extends around said axis;
the drum comprises an inner cylindrical surface and laundry tumbling bosses which project from this inner cylindrical surface, at least one of these bosses forming said element;
the bosses form independent extinguishing devices;
the bosses form part of a single extinguishing device and comprise inner spaces which are connected to one another to form a single storage volume for the extinguishing fluid;
the bosses are connected to one another by junction members providing the mechanical connection of the bosses to one another, on the one hand, and fluid communication of the inner spaces of the bosses, on the other hand;
the bosses and the junction members form a one-part assembly;
said one-part assembly is made entirely of thermoplastic fusible material;
the apparatus comprises a number of bosses of between 1 and 10, and preferably between 2 and 6;
the extinguishing device is carried by the door;
said element of the extinguishing device is in the form of a tubular ring or a portion of a tubular ring, which extends around said axis;
said element forms a seal around the loading opening or is located adjacent to a seal around the loading opening;
the extinguishing device is carried by the casing;
said element forms a seal around the loading opening or is located adjacent to a seal around the loading opening;
the door is or comprises a porthole;
the extinguishing device comprises a first part which is located in said cavity and a second part which is located outside the cavity and in the casing;
the first part is located at the level of the loading opening and is in the form of a ring, a portion of a ring or a tubular loop;
the first part forms a seal or is located adjacent to a seal;
the second part is attached to one of the walls of the casing;
   the ring portion is closed at both ends;
   the device may be in the form of a single piece or several independent or interconnected pieces;
   the or each extinguishing device is provided with at least one sensor which is connected to a control member;
   said control member may be accessed by a user via, for example, a control panel on this apparatus or any other means of exchanging information (e.g., WiFi, Bluetooth®, IR, etc.);
   said control member is a member for controlling the apparatus;
   the sensor is a pressure, temperature or other parameters sensor;
   said member can be configured to put the apparatus out of service when said sensor emits a particular signal; for example, said member is configured to put the apparatus out of service when said pressure sensor emits a signal corresponding to a pressure of said fluid below a predetermined threshold;
   said member is configured to emit a signal to a portable electronic device, such as a portable computer or a portable phone of the smartphone type, for example;
   said member is configured to emit a signal to a computing network (e.g., home automation) or a computing database, such as a network or a database configured to ensure a management of a set of several apparatus with a view to their maintenance;
   said signal transmission is carried out remotely and wirelessly, for example by Wi-Fi, Bluetooth®, IR, etc.;
   the device is one-part;
   the fluid is under pressure;
   the fluid is at a pressure greater than 1 bar and less than or equal to 30 bar, preferably between 1 and 20 bar and for example between 1 and 10 bar;
   the fluid is in the liquid or gaseous state at ambient temperature (for example between 15 and 25° C.);
   the apparatus comprises a system for heating and generating a flow of hot air is located under the drum or on one side of the drum;
   the apparatus comprises a motor for driving in rotation the drum about its axis;
   the drum comprises micro perforations for the passage of air and/or water.

### BRIEF DESCRIPTION OF THE FIGURES

The invention will be better understood, and other details, characteristics and advantages of the present invention will become clearer from the following description made by way of non-limiting example and with reference to the attached drawings, in which:

FIG. 1 is a schematic perspective view of a laundry drying and/or washing apparatus,

FIG. 2 is a schematic perspective view of another apparatus for drying and/or washing laundry,

FIG. 3 is a schematic perspective view of another apparatus for drying and/or washing laundry,

FIG. 4 is a schematic perspective view of a drum of a laundry drying and/or washing apparatus,

FIG. 5 is a schematic perspective view of another drum in a laundry drying and/or washing apparatus,

FIG. 6 is a schematic partial perspective view of a laundry drying and/or washing apparatus with the door open,

FIG. 7 is a very schematic view of a drum of a laundry drying and/or washing apparatus, this drum comprising an extinguishing device according to a first embodiment of the invention,

FIG. 8 is a partial schematic perspective view of a laundry drying and/or washing apparatus, the drum of which comprises an extinguishing device according to a second embodiment of the invention,

FIG. 9 is a schematic partial perspective view of a laundry drying and/or washing apparatus, the door of which comprises an extinguishing device according to a third embodiment of the invention,

FIG. 10 is a schematic partial perspective view of a laundry drying and/or washing apparatus, the loading opening of which comprises an extinguishing device according to a fourth embodiment of the invention, and

FIG. 11 is a schematic partial perspective view of a laundry drying and/or washing apparatus, the casing of which carries an extinguishing device according to a fifth embodiment of the invention.

### DETAILED DESCRIPTION OF THE INVENTION

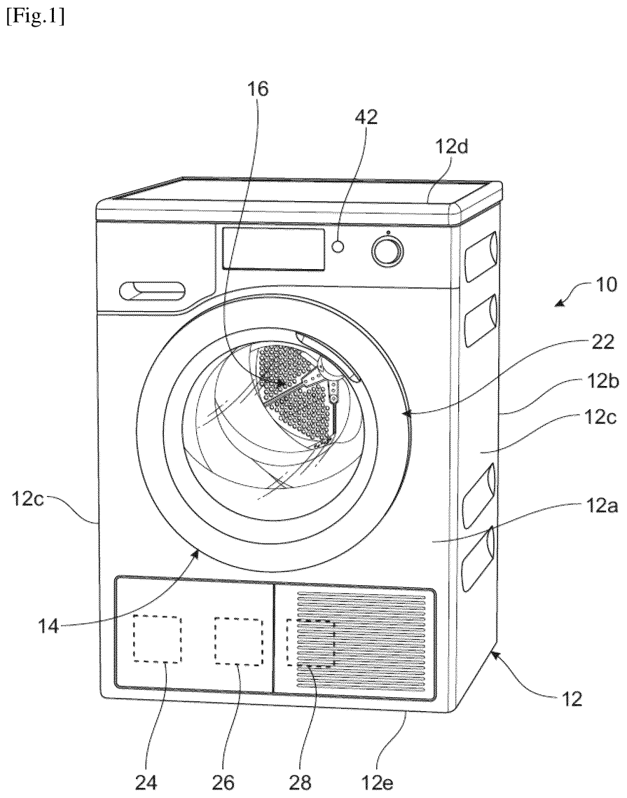

FIG. 1 is a schematic representation of an apparatus 10 for drying and/or washing laundry, such as a tumble dryer, i.e., a household electrical apparatus designed to dry laundry by tumbling it and subjecting it to a flow of hot air. The apparatus 10 may be configured for private or professional use

The apparatus 10 comprises a generally parallelepiped-shaped outer casing 12 which comprises walls, for example a front wall 12a, a rear wall 12b, two opposing side walls 12c, a top wall 12d and a bottom wall 12e.

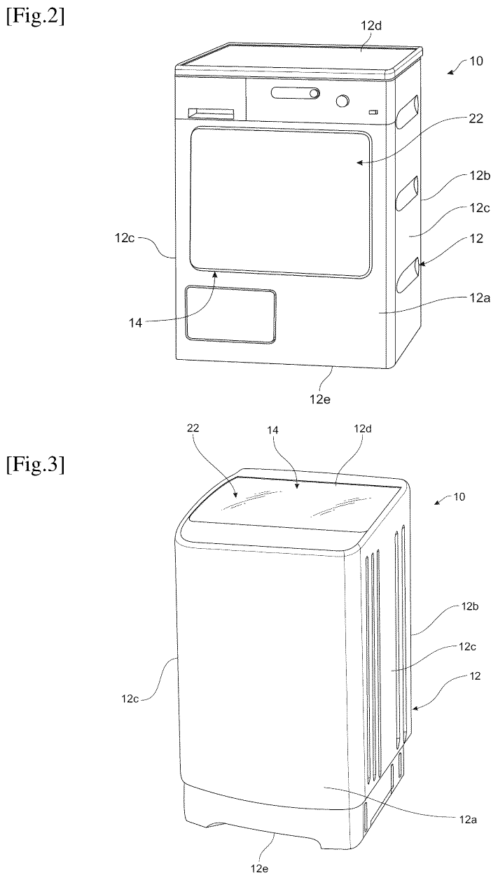

One of these walls 12a-12e comprises an opening 14 for loading laundry into the apparatus 10. This opening 14 may be located on the front wall 12a as in FIGS. 1 and 2, or on the top wall 12d as in FIG. 3.

The apparatus 10 also comprises a drum 16 located in the casing 12 and rotatable about an axis A. This axis A is generally horizontal but could alternatively be inclined. In the case of a front-loading apparatus 10 as shown in FIGS. 1 and 2, this axis A generally passes through the front 12a and rear 12b walls. In the case of a top-loading apparatus 10 as shown in FIG. 3, this axis A generally passes through the side walls 12c.

The drum 16 comprises an inner cavity 18 connected to the loading opening 14 and configured to receive laundry. The drum 16 defines any washing and/or drying volume that is adapted to its use (private or professional).

The drum 16 is generally made mainly of sheet metal. It comprises a cylindrical wall 16a extending around the axis A and a circular wall 16b at one or both of its axial ends.

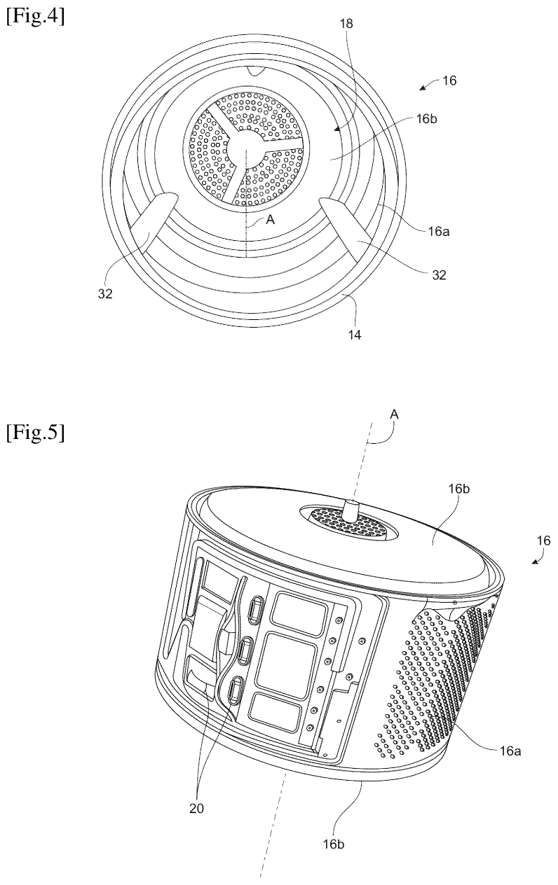

The drum 16 shown in FIG. 4 is configured to equip a front-loading apparatus (FIGS. 1 and 2) and comprises a single circular wall 16b, to the rear of the cylindrical wall 16b. The front face of the drum 16 is therefore open and is located on the side of the loading opening 14.

The drum 16 shown in FIG. 5 is configured for a top-loading apparatus 10 (FIG. 3) and comprises two circular walls 16b located at the axial ends of the cylindrical wall 16a. Both sides of the drum 16 are therefore closed. These walls 16b or faces of the drum are configured to be located opposite the side walls 12c of the casing 12 and are therefore lateral walls or faces. The cylindrical wall 16a comprises a hatch 20 that communicates with the loading opening 14. This hatch 20 must be located on the side of the top wall 12d of the casing 12 to gain access to the cavity 18 via the loading opening 14.

The drum 16 may comprise micro perforations through which air and/or water may pass during drying or spin-drying of the laundry, for example.

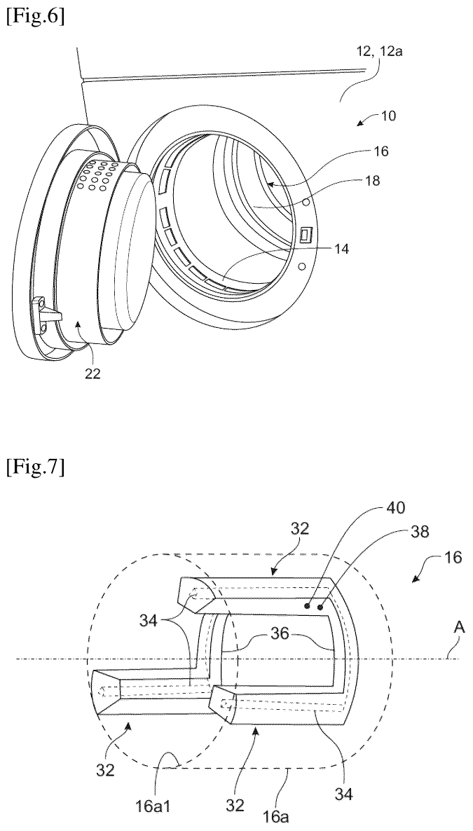

The apparatus 10 also comprises a door 22 for closing the loading opening 14, this door 22 being movable between positions for closing and opening the cavity 18 (FIG. 6).

In the case of a front-loading apparatus 10 (FIGS. 1, 2 and 6), the door 22 is movable about a vertical axis, this axis being located on one side of the door 22. In the case of a top-loading apparatus 10 (FIG. 3), the door 22 is movable about a horizontal axis, this axis being located at the rear of the door.

The door 22 may comprise or be formed by a porthole (FIGS. 1 and 6) or be solid (FIGS. 2 and 3).

As shown very schematically in FIG. 1, an apparatus 10 of this type further comprises:
a motor 24 for driving in rotation the drum 16 about its axis A, which is located inside the casing 12; the motor 24 comprises an output shaft which drives in rotation the drum 16 by means of a belt, for example,
a system 26 for heating and generating a flow of hot air in the cavity 18 of the drum 16; the heating system 26 may be of any type and is for example of the resistance heating type, gas burner type, etc., and
other elements 28 such as, in particular, an electronic member for monitoring and controlling the various electrical items of equipment in the apparatus, a condenser or a conduit for discharging hot air laden with moisture, etc.

According to the invention, the apparatus 10 also comprises an autonomous extinguishing a fire or fire outbreak device 30. This device 30 is advantageously located in the cavity 18 of the drum 16 and may be carried by the door 22, the drum 16 and/or the casing 12.

The device 30 comprises at least one element made of a thermoplastic fusible material and comprising an inner space containing an extinguishing fluid configured to be released when the element melts under the effect of the heat generated by a fire or fire outbreak.

FIGS. 7 to 11 illustrate several embodiments of an apparatus according to the invention.

In the first embodiment shown in FIG. 7, the drum 16 is represented schematically by dotted lines. The cylindrical wall 16a of the drum 16 comprises an inner cylindrical surface 16a1.

In a known manner, the drum 16 comprises bosses 32 or laundry tumbling vanes, which project from the surface 16a1 (see FIGS. 4 and 7). These bosses 32 are, for example, evenly distributed around the axis A. The number of these bosses 32 is between 1 and 10, and preferably between 2 and 6.

In the first embodiment shown in FIG. 7, it is the drum 16 that carries the extinguishing device 30. More precisely, the bosses 32 on the drum 16 carry or form one or more extinguishing devices 30.

In the first configuration, the bosses 32 form independent extinguishing devices 30. That is to say, the bosses 32 each form one of the aforementioned elements and each comprise an inner space 34 containing the extinguishing fluid. The inner spaces 34 of the elements and bosses 32 are independent of each other.

In the second configuration, the bosses 32 form a single extinguishing device 30. In other words, the bosses 32 form elements which comprise inner spaces 34 containing the extinguishing fluid. The inner spaces 34 of the elements and bosses 32 communicate with each other to form a single storage volume for the extinguishing fluid. To achieve this, the bosses 32 may be connected to each other by junction members 36, which ensure the mechanical connection of the bosses 32 to each other, on the one hand, and also the fluidic communication of the inner spaces 34 of the bosses 32, on the other. The bosses 32 and the junction members 36 may form a one-part assembly.

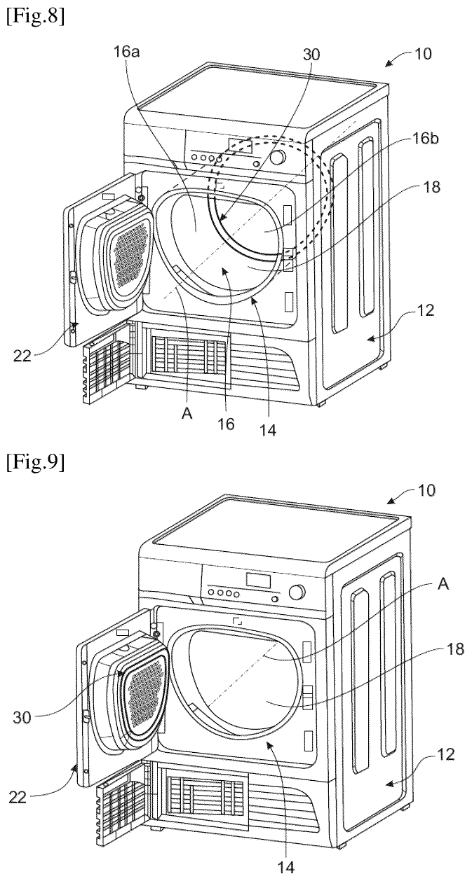

In the second embodiment shown in FIG. 8, it is the drum 16 that carries the extinguishing device 30, which is in the form of a tubular ring or a portion of a tubular ring.

The ring or the ring portion extends around the axis A and is located on the rear wall 16b of the drum 16 and for example on its periphery, at the level of its junction with the cylindrical wall 16a. The ring or the ring portion comprises an inner storage space for extinguishing fluid, which preferably extends along the entire length of the ring or ring portion.

In the third embodiment shown in FIG. 9, the door 22 carries the extinguishing device 30. The device 30 is preferably located on the face, in this case the rear face, of the door 22, which is located in the cavity 18 when the door 22 is closed.

The device 30 may also take the form of a ring, ring portion or tubular loop, for example. This element comprises an inner storage space for the extinguishing fluid, which preferably extends along the entire length of the ring or ring portion. The ring or ring portion may, for example, form a seal around the loading opening 14 or be located adjacent to a seal around the loading opening 14.

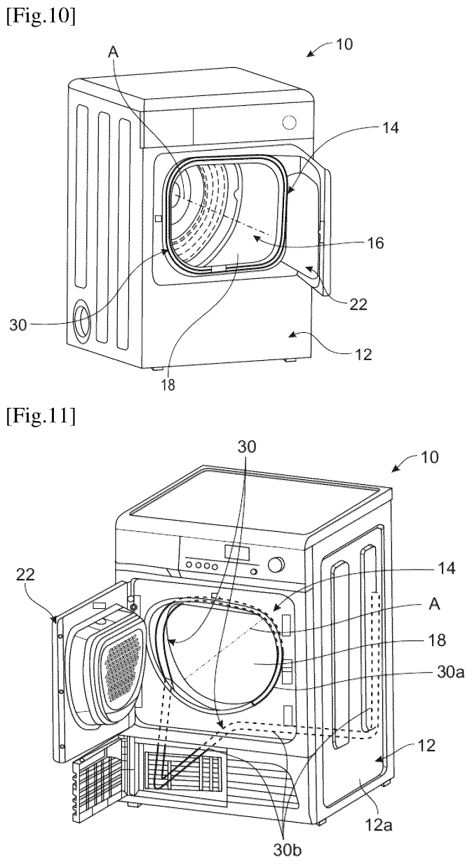

In the fourth embodiment shown in FIG. 10, the extinguishing device 30 is located at the level of the loading opening 14 of the apparatus 10. The device 30 may be carried by the drum 16, the casing 12, or both.

In the fifth embodiment shown in FIG. 11, the extinguishing device 30 is located partly at the level of the loading opening 14 of the apparatus 10 and partly outside the cavity 18 of the drum 16. In this case, the device 30 may be carried by the drum 16, the casing 12, or both.

The device 30 thus comprises a first part 30a which is located in the cavity 18, at the level of the loading opening 14, and a second part 30b which is located outside the cavity 18 and in the casing 12.

The first part 30a of the device 30 may be in the form of a ring, ring portion or tubular loop, for example. This element comprises an inner storage space for the extinguishing fluid, which preferably extends along the entire length of the ring or ring portion.

The first part 30a may, for example, form a seal around the loading opening 14 or be located next to a seal around the loading opening 14.

The second part 30b may extend into the casing 12, as described in the previous application FR-A1-3 110 608, and be attached by suitable means to one of the walls, here side walls 12c, of the casing 12.

In the various embodiments described above, the device 30 is advantageously provided with a valve 38 for filling its inner space with extinguishing fluid, as described in the application FR-A1-3 088 215 (see FIG. 7).

The device 30 may be provided with a pressure sensor 40 which is configured to measure the pressure of the fluid 29 and which is connected to a control and command member 42 of the apparatus 10 (see FIGS. 1 and 7).

This member 42 is configured to put the apparatus 10 out of service when the pressure sensor 40 emits a signal corresponding to a fluid pressure below a predetermined threshold. The member 42 may also be configured to emit a signal to a portable electronic device such as a mobile phone of the smartphone type, in order to warn the user or the owner of the apparatus if it malfunctions.

Alternatively, the device 30 could be provided with a sensor for measuring parameters other than pressure, such as temperature.

The wall of the element or of the device 30 may be of the single-layer or multi-layer type. For example, it may comprise two layers, inner and outer respectively.

The inner layer may be made of a material with a low permeability relative to the extinguishing fluid 29, i.e., a permeability of less than or equal to 1 cm³·25 μm/m²·atm·24 h. For example, it is made of a fluorinated thermoplastic material or EVOH.

The external layer is made from a polyamide thermoplastic material, which generally has a higher permeability than the inner layer, for example greater than or equal to 1 cm³·25 μm/m²·atm·24 h.

It is preferable for the lower permeability layer to be located inside the higher permeability layer. Otherwise, there would be a risk of migration of the gas through the more permeable inner layer and of stagnation of this gas at the interface between the two layers, which could lead to a delamination of the layers.

It is also advantageous to produce the element or the device in two layers rather than a single layer of low-permeability material, as this material is relatively expensive. To provide a sufficient resistance, particularly to pressure, a single-layer element should have a significant thickness of low-permeability layer. In the case of a two-layer or multi-layer element, this resistance is provided by the layer or layers with the highest permeability, and the layer with the lowest permeability may have a relatively low thickness, sufficient to provide the desired impermeability function.

In another variant not shown, the low-permeability layer could be arranged between two layers. This configuration allows to improve the mechanical strength of the layer during the element forming step (and thus avoid any risk of the layer tearing), while guaranteeing an optimum sealing of the element.

At least one of the materials of the wall is fusible under the effect of the heat generated by a fire or a starting fire, and in particular under the effect of a temperature greater than or equal to 70° C., or even 120° C.

In the example described above, both layers have such a fusible property.

In a particular example of embodiment of the invention, the ring or the ring portion of the element has an external diameter of between 10 and 30 mm, and preferably between 10 and 20 mm. The wall is between 1 and 3 mm thick, preferably between 1 and 2 mm.

The extinguishing fluid may be stored in the above-mentioned space at a pressure of more than 1 bar, which may be as high as 10 bar, 20 bar or even 30 bar.

The extinguishing fluid preferably does not comprise an HFC gas of the R236Fa type because this gas has a very high GWP (Global Warming Potential) of around 9400.

The extinguishing fluid preferably has a GWP equal to or less than 5000. The fluid may comprise at least one HFC gas and/or C₆F₁₂O and/or CO₂. Among the HFC gases that may be used, R227ea and R125 are preferred because they have a GWP of around 3400-3500. DuPont® company, for example, markets gases of this type under the names FE-25 and FM-200.

CO₂ is advantageous because it has a GWP of 1.

Finally, C₆F₁₂O is also advantageous because it has a GWP of 1. 3M company markets this type of gas under the name Novec® 1230 (FK-5-1-12).

1. An apparatus for drying and/or washing laundry, comprising:
an outer casing of generally parallelepiped shape, this casing comprising walls, at least one of which comprises a laundry loading opening,
a drum located in said casing and being rotatably movable about an axis, this drum comprising an inner cavity connected to the loading opening and configured to receive the laundry,
a door for closing the loading opening, this door being movable between positions for closing and opening said cavity, and
at least one autonomous fire extinguishing device, this device comprising at least one element made entirely of thermoplastic fusible material and an inner space containing an extinguishing fluid configured to be released when the element melts under the effect of the heat generated by a fire or fire outbreak,
wherein the extinguishing device is located at least partly in said cavity.

2. The apparatus according to claim 1, wherein the extinguishing device is carried by the drum.

3. The apparatus according to claim 2, wherein said element of the extinguishing device is a tubular ring or a portion of a tubular ring, which extends around said axis.

4. The apparatus according to claim 2, wherein the drum comprises an inner cylindrical surface and laundry tumbling bosses which project from said inner cylindrical surface, at least one of said bosses forming said element.

5. The apparatus according to claim 4, wherein the bosses form independent extinguishing devices.

6. The apparatus according to claim 4, wherein the bosses form part of a single extinguishing device and comprise inner spaces which are connected to one another to form a single storage volume for the extinguishing fluid.

7. The apparatus according to claim 6, wherein the bosses are connected to one another by junction members providing the mechanical connection of the bosses to one another, on the one hand, and fluid communication of the inner spaces of the bosses, on the other hand.

8. The apparatus as claimed in claim 7, wherein the bosses and the junction members form a one-part assembly.

9. The apparatus as claimed in claim 8, wherein said one-part assembly is made entirely of thermoplastic fusible material.

10. The apparatus according to claim 4, wherein it comprises a number of bosses of between 1 and 10, and preferably between 2 and 6.

11. The apparatus according to claim 1, wherein the extinguishing device is carried by the door.

12. The apparatus according to claim 11, wherein said extinguishing device element is in the form of a tubular ring or a portion of a tubular ring, which extends around said axis.

13. The apparatus according to claim 12, wherein said element forms a seal around the loading opening or is located adjacent to a seal around the loading opening.

14. The apparatus as claimed in claim 1, wherein the extinguishing device is carried by the casing.

15. The apparatus according to claim 14, wherein said element forms a seal around the loading opening or is located adjacent to a seal around the loading opening.

16. The apparatus according to claim 1, wherein the door is or comprises a porthole.

17. The apparatus according to claim 1, wherein the extinguishing device comprises a first part which is located in said cavity and a second part which is located outside the cavity and in the casing.

18. The apparatus according to claim 17, wherein the first part is located at the level of the loading opening and is in the form of a ring, a portion of a ring or a tubular loop.

19. The apparatus according to claim 17, wherein the first part forms a seal or is located adjacent to a seal.

20. The apparatus according to claim 17, wherein the second part is attached to one of the walls of the casing.
